(19) United States
(12) Patent Application Publication
(10) Pub. No.: US 2021/0299948 A1
(43) Pub. Date: Sep. 30, 2021

(54) FUSED FILAMENT FABRICATION MANUFACTURING METHOD AND POLYMER BLEND USED THEREIN

(71) Applicant: Dow Global Technologies LLC, Midland, MI (US)

(72) Inventors: Craig F. Gorin, Midland, MI (US); Sanjib Biswas, Manvel, TX (US); Sharon Allen, Midland, MI (US); Scott T. Matteucci, Midland, MI (US); Daniel L. Dermody, Midland, MI (US); Harpreet Singh, Pearland, TX (US); Aleksander J. Pyzik, Midland, MI (US)

(21) Appl. No.: 17/264,737

(22) PCT Filed: Jul. 12, 2019
(86) PCT No.: PCT/US2019/041645

§ 371 Date: Jan. 29, 2021

Related U.S. Application Data
(60) Provisional application No. 62/743,164, filed on Oct. 9, 2018.
(60) Provisional application No. 62/712,302, filed on Jul. 31, 2018.

(51) Int. Cl. B29C 64/118; B33Y 70/00; B33Y 10/00; B29C 48/50

(52) U.S. Cl. CPC B29C 64/118; B33Y 70/00; B29K 2023/0633; B29C 48/50; B33Y 10/00

(57) ABSTRACT

A method of fused filament fabrication (FFF) additive manufacturing comprises employing a thermoplastic blend comprised of high density polyethylene and a second thermoplastic polymer, wherein the second polymer is a low density polyethylene (LDPE), functionalized polyolefin or combination thereof and the amount of high density polyethylene to the amount of second thermoplastic polymer by weight is a ratio from 1.5/1 to 20/1. LDPE means a polyethylene that have been radically polymerized at high pressure. The method allows for the additive manufacturing article that retains the desirable mechanical properties of HDPE without experiencing the problems inherent in FFF printing of HDPE or use of solid fillers. In a particular embodiment, the additive manufactured article has a continuous phase and the second thermoplastic polymer is present as a discontinuous phase within the additive article manufactured article and the filament used to make the article.

### FIELD OF THE INVENTION

The invention relates to a method of additive manufacturing in which thermoplastic polymer powders are melted and extruded, for example, using filaments that are advanced and heated through a nozzle and deposited on a platen (commonly referred to as fused filament fabrication). In particular, the invention is one enables thermoplastic polymers primarily comprised of high-density polyethylene that are otherwise unable to be used due to poor warpage and adhesion in an additive manufacturing process.

### BACKGROUND OF THE INVENTION

Additive manufacturing of thermoplastic polymers (typically nylon) is well known. For example, fused filament fabrication (FFF), which is also commonly called plastic jet printing has been used to form 3d parts by using thermo-plastic filaments that are drawn into a nozzle, heated, melted and then extruded where the extruded filaments fuse together upon cooling (see, for example, U.S. Pat. No. 5,121,329). Because the technique requires melting of a filament and extrusion, the materials have been limited to thermoplastic polymers (typically nylon) and complex apparatus. In addition, the technique has required support structures that are also extruded when making complex parts that must survive the elevated temperature needed to form the part, while also being easily removed, for example, by dissolving it or releasing it by dissolving a layer between it and the final article such as described by U.S. Pat. No. 5,503,785.

The use of nylon or other polymers having polar groups has been necessitated to ensure adequate bonding between the layers deposited during formation of the 3d printed part (lack of adhesion in the z-direction). Likewise, polymers displaying crystalline formation in particular orientations such as high-density polyethylene (HDPE) have also tended to warp and not adequately print. For these reasons the HDPE has not been successfully FFF 3d printed commercially. Blends of polymers having small amounts of HDPE have been reported to be printed such as described in WO2016080573. Likewise, high levels of filler solid fillers have been used to lessen the detrimental crystallization of HDPE (e.g., CN104629152A and CN105295175), but invariably the levels of filler necessary to allow for adequate printing substantially reduces the desirable mechanical properties of such parts formed with HDPE.

It would be desirable to provide a method of printing a polymer comprising HDPE that maintains the desirable properties of HDPE while avoiding one or more of the prior art 3D printing HDPE problems.

### SUMMARY OF THE INVENTION

We have discovered an improved method of fused filament fabrication additive manufacturing comprising,

(i) providing a thermoplastic blend comprised of high-density polyethylene (HDPE) and a second thermoplastic polymer (STP), wherein the second polymer is a low-density polyethylene, functionalized polyolefin or combination thereof and the amount of high-density polyethylene to the amount of second thermoplastic polymer by weight is a ratio from 1.5/1 to 20/1,

(ii) heating and dispensing said thermoplastic blend through a nozzle to form an extrudate deposited on a base,

(iii) moving the base, nozzle or combination thereof while dispensing the thermoplastic blend so that there is horizontal displacement between the base and nozzle in a predetermined pattern to form an initial layer of the material on the base, and

(iv) repeating steps (ii) and (iii) to form a successive layer of the material adhered on the initial layer to form an additive manufactured part.

A second aspect of the invention is an additive manufactured article comprised of at least two layers of a plurality of extrudates comprised of a blend of high-density polyethylene and second thermoplastic polymer, wherein the second polymer is a low density polyethylene, functionalized polyolefin or combination thereof and the amount of high density polyethylene to the amount of second thermoplastic polymer by weight is a ratio from 1.5/1 to 20/1.

A third aspect of the invention is a filament useful for additive manufacturing, comprising a filament that is comprised of a thermoplastic blend comprised of high-density polyethylene and a second thermoplastic polymer, wherein the second thermoplastic polymer is a low-density polyethylene, functionalized polyolefin or combination thereof and the amount of high-density polyethylene to the amount of second thermoplastic polymer by weight is a ratio from 1.5/1 to 20/1.

The improved additive manufacturing method may be used to form an additive manufactured polymeric part that has the desirable properties of high-density polyethylene (HDPE) while avoiding 3D printing problems associated with printing HDPE such as warpage, lack of adhesion in the z direction (height). The method is particularly suited to make a thermoplastic part the FFF method that is primarily comprised of HDPE without additives such as fillers that are solid at the melt temperature or 3D printing temperature used in FFF.

### BRIEF DESCRIPTION OF THE DRAWINGS

FIG. 1 is a side view of the additive manufactured article of this invention being made by the method of this invention.

FIG. 2 is an end view of the extrudates of the initial layer being formed in the method of this invention.

FIG. 3 is an end view of the finished initial layer of the method of this invention.

FIG. 4 are photographs of a comparative example additive manufactured article using HDPE alone and three examples of additive manufactured articles using HDPE with a second thermoplastic polymer of this invention.

### DETAILED DESCRIPTION OF THE INVENTION

The additive manufacturing method may use any suitable apparatus and method for FFF manufacturing of parts such as those known in the art (i.e., the method steps of heating, dispensing, repeating and removing) as described above utilizing a filament that has been made previously and then loaded into known FFF printing apparatus. The method may also melt blend the materials at or prior to the nozzle and extrude an extrudate in a more conventional manner while forming the additive manufactured as follows.

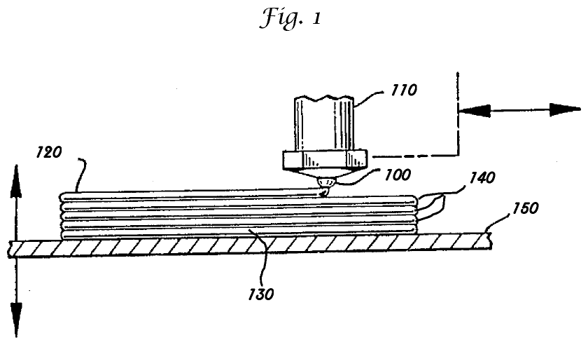

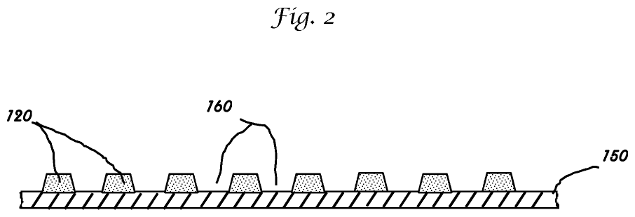

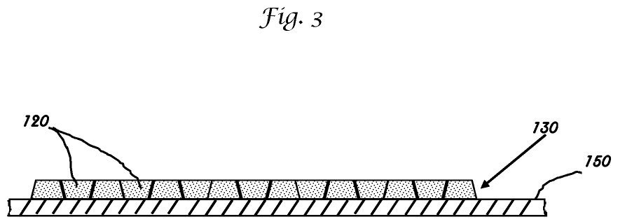

Turning to FIGS. 1-3, the method comprises heating and dispensing the thermoplastic blend through nozzle 100 attached to the nozzle assembly 110. Upon dispensing the material forms an extrudate 120 that forms an initial layer 130 and successive layers 140 on base 150. Nozzle assembly 110 is depicted being orthogonal to base but may be set at any useful angle to form the extrudate whereby the extrudate 120 and nozzle assembly 110 form an obtuse angle with the extrudate 120 being parallel to the base. In addition, the nozzle assembly 110 may be rotated about its longitudinal axis, for example, to reorient the shape of the opening in the nozzle 100, to create extrudates 120 having differing relationship to the base 150 as shown in FIGS. 1-3.

The relative motion of the base 150 and nozzle assembly 110 are also shown, but it is understood that the base 150, nozzle assembly 110 or both may be moved to cause the relative motion in any horizontal direction or vertical direction. The motion is made in a predetermined manner, which may be accomplished by any known CAD/CAM methodology and apparatus such as those well known in the art and readily available robotics or computerized machine tool interface. Such pattern forming is described, for example, in U.S. Pat. No. 5,121,329.

The extrudate 120 may be dispensed continuously or disrupted to form the initial layer 130 and successive layers 140. If disrupted extrudates 120 are desired, the nozzle may be comprised of a valve (not pictured) to shut off the flow of the material. Such valve mechanism may be any suitable such as any known electromechanical valves that can easily be controlled by any CAD/CAM methodology in conjunction with the pattern.

Because the material may be adhesive, the base 150 may be a low surface energy material fluorinated polymer such as Teflon and the like. Alternatively, the base may have a mold release agent such as those known in the polyurethane reaction injection molding art or the base may have a sheet of paper or film of a low energy material placed upon it prior to dispensing and forming the additive manufactured part.

More than one nozzle assembly 110 may be employed to make composite or gradient structures within the additive manufactured part. Likewise, a second nozzle assembly 110 may be employed to dispense a support structure that may be later removed to allow more complex geometries to be formed such as described in U.S. Pat. No. 5,503,785. The support material may be any that adds support and be removed easily such as those known in the art, for example, waxes.

The method employs a thermoplastic blend comprised of high-density polyethylene (HDPE) and a second thermoplastic polymer, wherein the second polymer is a low-density polyethylene, functionalized polyolefin or combination thereof. The amount of HDPE to the amount of second thermoplastic polymer by weight is a ratio from 1.5/1 to 20/1.

The HDPE may be any known HDPE such as those commercially available. HDPE has the common understanding within the art, wherein HDPE is characterized by the catalysts used to make them such as Philips Chromium catalyst, Ziegler catalysts or metallocene catalysts. HDPE has marginally higher density and is more crystalline than low density polyethylenes with little or essentially no branching resulting in a more crystalline polymer than LDPE. HDPE is characterized by a higher strength to weight ratio compared to LDPE. Typically HDPE will have a density of about 9.4 to 9.65 and a melt index from about 0.1 to about 50 and preferably from about 0.25 to 40 (ASTM D1238). Exemplary commercially available HDPEs include, but not limited to, DMDA-8007 NT 7 (Melt Index 8.3, Density 0.965), DMDC-8910 NT 7 (Melt Index 10, Density 0.943), DMDA-1210 NT 7 (Melt Index 10, Density 0.952), HDPE 17450N (Melt Index 17, Density 0.950), DMDA-8920 NT 7 (Melt Index 20, Density 0.954), DMDA 8940 NT 7 (Melt Index 44, Density 0.951), DMDA-8950 NT 7 (Melt Index 50, Density 0.942), DMDA-8965-NT 7 (Melt Index 66, Density 0.952), DMDC-1210 NT7 (Melt Index 10, Density 0.952) all available from The Dow Chemical Company. Other exemplary HDPEs may include HDPE HD6601.29 (Melt Index 5, Density 0.948) and HDPE HD6733.17 (Melt Index 33, Density 0.950) all available from Exxon Mobil; Alathon H5220 (Melt Index 20, Density 0.952) and Alathon M4661 (Melt Index 6.1, Density 0.946) all available from Lyondell Basell; Lutene H Me8000 (Melt Index 8.0, density 0.957) available from LG Chem; and HDPE CC254 (Melt Index 2.1, Density of 0.953) available from Sabic.

The second thermoplastic polymer (STP) used with the HDPE to form the thermoplastic blend is a low-density polyethylene (LDPE), functionalized polyolefin or combination thereof. LDPE means a polyethylene that has been radically polymerized at high pressure resulting in substantial branching compared to HDPE and linear low-density polyethylene (LLDPE). Typically, the LDPE has a density from about 0.91 to about 0.93 and a melt index of about 0.1 to 50 and more typically from about 0.5 to 40. Exemplary commercially available LDPEs that may be suitable include those available from The Dow Chemical Company (Midland Mich.) such as LDPE 150E ((Melt Index 0.25, Density 0.921) LDPE 421E ((Melt Index 3.2, Density 0.930) LDPE 780E ((Melt Index 20, Density 0.923) LDPE 722 ((Melt Index 8, Density 0.918), AGILITY 1021 (Melt Index 1.9, Density 0.919HP7023 (Melt Index 7.0, Density 0.932) from Sabic,), Lupolen 1800S (Melt Index 20, Density 0.917) from Lyondell Basell, LDPE LD 102.LC (Melt Index (6.8, Density 0.921) and LDPE LD 136.MN (Melt Index 2.0, Density 0.912) from Exxon Mobil.

A functionalized polyolefin is a polyolefin comprising atoms other than carbon and hydrogen, for example, the functionalized polyolefin may be modified with hydroxyl, an amine, an aldehyde, an epoxide, an ethoxylate, a carboxylic acid, an ester, an anhydride group, or combinations thereof. Generally, a functionalized polyolefin comprises functional groups such as protonated (—COOH) or non-protonated (—COO—) acid groups or acid salt. include ethylene/acrylic acid copolymer (for example, polymers sold under the tradename PRIMACOR™ (a trademark of The Dow Chemical Company (“Dow”)), NUCREL™ (a trademark of E.I. du Pont de Nemours and Company) and ESCOR™ (ESCOR is a trademark of Exxon Corporation)), ethylene/methacrylic acid copolymers (for example, polymers sold under the tradename NUCREL™), maleic anhydride modified polyolefins (for example polymers sold under the tradenames LICOCENE™ (a trademark of Clariant AG Corporation), EPOLENE™ (EPOLENE is a trademark of Westlake Chemical Corporation) and MORPRIME™ (a trademark of Rohm and Hass Chemicals LLC)). Ethylene ester copolymers such as those modified with vinyl acetate (ELVAX, E. I. du Pont de Nemours and Company, Wilmington Del. (“DuPont”)), Acrylate modified (ELVALOY available from DuPont) and AMPLIFY (Dow)). Likewise, subsequent ionomers of the functionalized polyolefins formed via neutralization with cations from metals such as Zn, Na, Mg or K, with an example being SURLYN available from Dupont.

The amount of the HDPE and second thermoplastic polymer in the thermoplastic blend by weight is at a ratio where the majority of the thermoplastic blend is HDPE such that the ratio of HDPE/Thermoplastic polymer is from 1.5/1 to 20/1. Preferably the amount of HDPE/(STP) is 2/1, 5/1 or 10/1 to 15/1. In one embodiment, the thermoplastic blend has no other components in the blend and is preferred.

In one embodiment, the thermoplastic blend is in the form of pellets that are subsequently heated and extruded during the additive manufacturing process. In another embodiment, the thermoplastic blend is in the form of a filament. Each of these may be made by processes known in the art. The filament when using HDPE with the particular STPs surprisingly realizes a microstructure that is believed to enable the formation of an additive manufactured article having the desired mechanical properties of HDPE, while allowing for excellent z-direction adherence and minimal or no warpage.

In one embodiment, the HDPE is a continuous matrix and the STP is discontinuously dispersed (referred to as “grains” herein) within the continuous matrix of the HDPE within the filament or printed article. Generally and desirably, the scale of the features of the STP are of a scale that is substantially smaller than the size of the diameter of the filament (e.g., the size of the grains are at least 5 or 10 times smaller than the diameter of the filament). Illustratively, the STP grains are less than about 5 micrometers and in some embodiments be sub-micron particles (e.g., less than about 1 micrometer) dispersed in the HDPE continuous phase. The grains may have any shape, but tend to be spherical. These features can be evenly dispersed, or have a concentration gradient. The STP grains and microstructure of the filament or manufactured article may be observed by microscopy techniques such as Atomic Force Microscopy or Scanning Electron Microscopy.

In one embodiment the thermoplastic blend has one or more optional components such as a pigment, filler, lubricant, slip agent, or flame retardant so long as the majority of the blend is HDPE. Other components may include additives to improve one or more properties or functionalities such as compatibilization of the HDPE and STP, or mechanical properties of the final article. Nucleating agents such as HPN-20E from Milliken could also be added to further improve shrinkage characteristics. Internal lubricants or process aids could include those such as Dynamar FX5911 (3M), Kynar PPA (Arkema) or Licolub H 12 or Licowax pe 520 (Clariant). The thermoplastic blend may include inorganic particles typically referred to as fillers, and dyes and anti-caking/flow control agents (e.g., fumed silica). The dyes may be inorganic (e.g., carbon black or mixed metal oxide pigments) or organic dyes such as inoaniline, oxonol, porphine derivative, anthaquinones, mesostyryl, pyrilium and squarylium derivative compounds. Fillers may be any typical fillers used in plastics such as calcium carbonate, silicates, oxides (quartz, alumina or titania).

The HDPE and STP typically have different temperatures where they melt as defined by the difference between the onset melting temperatures of the two polymers as determined by differential scanning calorimetry (DSC). Typically, the melt temperature of the HDPE and STP are within 20° C. or 10° C. of each other, but is not necessarily so. For example, as an illustration, the optimum melt temperature for a given material may not be a single temperature but a range over several degrees C. It is desirable for the STP to have a melting temperature lower than that of the HDPE.

The method produces a novel additive manufactured part wherein the part is comprised of at least two layers of extrudates adhered together between the layer layers, wherein the STP is interspersed within the HDPE on a scale smaller than the filament diameter or extrusion nozzle opening used to form the extrudates and the HDPE/STP weight ratio is from 1.5/1 to 20/1. The scale being akin to that described above for the grains within a filament. In a particular embodiment, the STP is dispersed in a continuous matrix of the HDPE and the STP grains are less than about 5 micrometers and in some embodiments less than 1 micrometer in diameter (equivalent spherical diameter).

### EXAMPLES

### Materials:

The materials to make the additive manufactured articles appear in Table 1

TABLE 1

| Material | Source | Information |
|---|---|---|
| HDPE DMDC | Dow | MI: 1.5 g/10 min, Density: 0.955 g/cc, |
| 1250 | | Mp: 130 C. |
| LDPE 722 | Dow | MI: 8.0 g/10 min, Density: 0.918 g/cc, |
| | | Mp: 105 C. |
| HDPE DMDA | Dow | MI: 44 g/10 min, Density: 0.951 g/cc, |
| 8940 NT 7 | | Mp: 128 C. |
| Elite 5230G | Dow | MI: 4 g/10 min, Density: 0.916 g/cc, |
| (LLDPE) | | Mp: 122 C. |
| Agility 1021 | Dow | MI: 1.9 g/10 min, Density: 0.919 g/cc, |
| (LDPE) | | Mp: 108 C. |
| Primacore | Dow*, | 9.7 wt % ethylene acrylic acid copolymer |
| 3460 | | MI: 20 g/10 min, Density: 0.938 g/cc, |
| | | Mp: 95 C. |

MI = melt index
MP = melting point;
*Now available from SK Chemical;

HDPE DMDC 1250 and HDPE DMDA 8940 NT-7 were used as supplied. Blends of HDPE & LDPE, LLDPE, or PRIMACOR copolymer were formed by melt blending in single screw extruder to produce pellets. The pellets were then formed into filaments by feeding the desired pellets into a single screw extruder heated to 190° C. with the screw turning at 10 rpms, the polymer melt was extruded through a 1.8 mm nozzle forming a filament having essentially the same diameter. Other diameters may be made depending on the size of the part to be manufactured and the particular 3D printing capabilities with it being common to have the filament be on the order of size ranging from less than a mm (−0.5 mm) 10 mm.

### Printing:

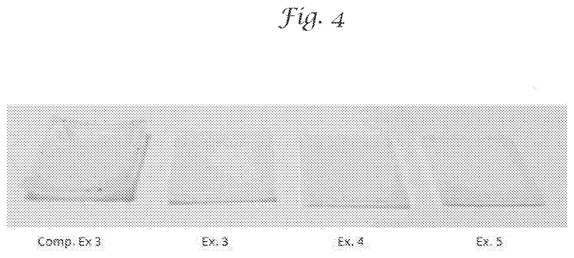

Parts were printed on a MakerBot Replicator 2X, which is commercially available from Stratasys Ltd, Minneapolis, Minn. (USA). Small three-dimensional boxes (with dimensions 2 cm×2 cm×1 mm) with layer height 0.2 mm with full infill were printed. Printer bed temp was 110° C., while nozzle temp was 210° C. The results of printing is shown in Table 2. The print quality was in part determined by measuring the corner gap height of the corners from flat. If the part was not printed fully, it was because of large distortions and gaps during printing rendering further printing useless. The results of the Examples and Comparative Example parts printed is shown in Table 2. Likewise, a picture of the printed articles of Comparative Example 3 and Examples 3-5 is shown in FIG. 4.

TABLE 2

| | | | | Com- | Avg |
|---|---|---|---|---|---|
| | | | | pleted | Corner |
| | | | | Printing | Gap |
| | | % | Density | Full | Height |
| Example | Formulation | HDPE | (g/cm³) | Part | (mm) |
| Comp 1 | DMDC 1250 | 100 | 0.955 | No | — |
| Comp 2 | 99% 1250, 1% LDPE 722 | 99 | 0.955 | No | 2.6 |
| Ex 2 | 90% 1250, 10% LDPE 722 | 90 | 0.951 | Yes | 0 |
| Comp 3 | DMDA 8940 | 100 | 0.951 | Yes | 2.7 |
| Ex 3 | 95% 8940, 5% | 95 | 0.950 | Yes | 0.7 |
| | Primacor 3460 | | | | |
| Ex 4 | 90% 8940,10% | 90 | 0.950 | Yes | 0.1 |
| | Primacor 3460 | | | | |
| Ex 5 | 80% 8940, 20% | 80 | 0.948 | Yes | 0 |
| | Primacor 3460 | | | | |
| Ex 6 | 95% 1250, 5% Agility 1021 | 95 | 0.953 | Yes | 0.3 |
| Comp 4 | 95% 1250, 5% Elite 5230G | 95 | 0.953 | No | — |

From Table 2 and FIG. 4 it is readily apparent that the use of a minor amount of the second thermoplastic polymer with HDPE enables the printing of HDPE without warpage, holes or other distortion.

1. A method of additive manufacturing,
(i) providing a thermoplastic blend comprised of high-density polyethylene and a second thermoplastic polymer, wherein the second polymer is a low-density polyethylene, functionalized polyolefin or combination thereof and the amount of high-density polyethylene to the amount of second thermoplastic polymer by weight is a ratio from 1.5/1 to 20/1,
(ii) heating and dispensing said thermoplastic blend through a nozzle to form an extrudate deposited on a base,
(iii) moving the base, nozzle or combination thereof while dispensing the thermoplastic blend so that there is horizontal displacement between the base and nozzle in a predetermined pattern to form an initial layer of the material on the base, and
(iv) repeating steps (ii) and (iii) to form a successive layer of the material adhered on the initial layer to form an additive manufactured part.

2. The method of claim 1, wherein the method further comprises repeating step (iv) such that a plurality of successive layers are adhered and built up forming the additive manufactured part.

3. The method of claim 1, wherein the ratio of 10/1 to 20/1.

4. The method of claim 3, wherein the high-density polyethylene has a melt temperature and the second thermoplastic polymer has a melt temperature with high-density polyethylene melt temperature being greater than the melt temperature of the second thermoplastic polymer.

5. The method of claim 4, wherein the high-density polyethylene has a melt index and the second thermoplastic polymer has a melt index and the melt index of the high-density polyethylene and melt index of the second thermoplastic polymer have a melt index ratio of the high-density polyethylene melt index/second thermoplastic polymer melt index of 0.1 to 5.

6. The method of claim 5, wherein the melt index ratio is 0.2 to 1.

7. The method of claim 1, wherein the second thermoplastic polymer is a functionalized polyolefin.

8. The method of claim 7, wherein the functionalize polyolefin is an ethylene/acrylic acid copolymer, ethylene/methacrylic acid copolymers, maleic anhydride modified polyolefins, or a combination thereof.

9. The method of claim 1, wherein the high-density polyethylene and second thermoplastic polymer are melted prior to dispensing through the nozzle.

10. The method of claim 1, wherein the high-density polyethylene and second thermoplastic polymer are formed into a filament that is drawn into the nozzle and melted within the nozzle.

11. The method of claim 1, wherein the blend is comprised of one or more of a pigment, filler, lubricant, slip agent, or flame retardant.

12. An additive manufactured article comprised of at least two layers of a plurality of extrudates comprised of a blend of high-density polyethylene and second thermoplastic polymer, wherein the second polymer is a low-density polyethylene, functionalized polyolefin or combination thereof and the amount of high-density polyethylene to the amount of second thermoplastic polymer by weight is a ratio from 1.5/1 to 20/1.

13. The additive manufactured article of claim 12, wherein the high-density polyethylene is a continuous phase and the second thermoplastic polymer is present as a discontinuous phase within the additive article manufactured article.

14. The additive manufactured article of either claim 13, wherein the second thermoplastic polymer is present as submicron particles dispersed in the HDPE continuous phase.

15. The additive manufactured article of claim 14, wherein the second thermoplastic polymer is present as particles having a spherical shape and being less than 5 micrometers equivalent spherical diameter.

16. The additive manufactured article of claim 12, wherein the high-density polyethylene has a density of 0.94 to 0.965 and a melt index of 0.5 to 40.

17. The additive manufactured article of claim 12, wherein the second thermoplastic polymer is a low-density polyethylene having a density of 0.91 to 0.93 and a melt index of 0.5 to 40.

18. A filament useful for additive manufacturing, comprising filament that is comprised of a thermoplastic blend comprised of high-density polyethylene and a second thermoplastic polymer, wherein the second thermoplastic polymer is a low-density polyethylene, functionalized polyolefin or combination thereof and the amount of high-density polyethylene to the amount of second thermoplastic polymer by weight is a ratio from 1.5/1 to 20/1.

19. The filament of claim 18, wherein the high-density polyethylene is a continuous phase and the second thermoplastic polymer is present as a discontinuous phase within the filament.

20. The filament of claim 19, wherein the second thermoplastic polymer is present as particles having spherical shape with an equivalent spherical diameter of less than 5 micrometers in the HDPE continuous phase.
